(19) United States
(12) Patent Application Publication
(10) Pub. No.: US 2026/0217348 A1
(43) Pub. Date: Jul. 30, 2026

(54) GLOW IN THE DARK AND INFRARED REFLECTIVE ARTICLE

(71) Applicant: Scott Harrigan, Eel River Crossing (CA)

(72) Inventor: Scott Harrigan, Eel River Crossing (CA)

(21) Appl. No.: 19/144,702

(22) PCT Filed: Dec. 28, 2023
(86) PCT No.: PCT/IB2023/063358

§ 371 Date: Jun. 30, 2025

Related U.S. Application Data
(60) Provisional application No. 63/435,560, filed on Dec. 28, 2022.

(51) Int. Cl. B63C 9/20; B63C 9/08; C08K 3/22

(52) U.S. Cl. CPC B63C 9/20; B63C 9/082; C08K 3/22; C08K 2003/2227; C08K 2003/2289

(57) ABSTRACT

Buoyant articles for maritime use, which may be embodied in a lifering that has glow in the dark pigment that is provided to produce illumination at the exterior of the lifering to enhance the visibility of the lifering at night, and which also incorporates an infrared (IR) pigment substance in conjunction therewith to provide visibility with an IR viewing apparatus, such as night vision googles (NVGs), cameras and other devices incorporating infrared illuminating technology. The lifering may include webbing or a rope that is configured with IR illuminating properties to be picked up by NVGs or other devices capable of capturing infrared energy.

### CROSS-REFERENCE TO RELATED APPLICATIONS

This application claims benefit of and priority to U.S. Provisional Application Ser. No. 63/435,560, filed Dec. 28, 2022, the complete contents of which are herein incorporated by reference.

### BACKGROUND OF THE INVENTION

### 1. Field of the Invention

The invention relates to a buoyant article made in part of polymers having a glow in the dark (GID) pigment incorporated, such as strontium aluminate treated with europium. The buoyant article is made in further part of polymers having an infrared reflective (IR) pigment incorporated which is visible using specialty infrared reflective viewing eyewear, often called Night Vision Goggles (NVG) which incorporate infrared illuminators. The buoyant article may take the form of a lifering which is useful for maritime rescue operations.

### 2. Brief Description of the Related Art

Despite the existence of maritime rescue gear such as liferings, life jackets, lifeboats, and throw ropes, drowning at sea continues to be a leading cause of death for hundreds of thousands of people worldwide, each year. Many of these deaths are preventable. Rescue personnel attempting to use some of the above mentioned rescue gear are often hampered by conditions of low light visibility which prevents them from reaching the distressed and drowning individual with the needed rescue gear. This invention seeks to improve the functionality and effectiveness of buoyant rescue gear to facilitate their use by rescue personnel to save lives.

Buoyant articles used by rescue personnel at sea are well known, and may take the form of a lifering. The classic lifering presents as a tubular ring made from polymers such as high density polyethylene, which is required by safety regulations to be provided in bright colours such as yellow or orange, or in a quartered red and white design. Liferings are typically formed with a shell on the outside, and an internal filling of a foamable material such as a polyurethane to increase the buoyancy of the article. Liferings are typically provided in two standard sizes: a 24 inch diameter lifering, and a 30 inch diameter lifering. The 24 inch diameter liferings are regulated by local country-specific authorities such as Transport Canada or the United States Coast Guard. The 30 inch diameter liferings are regulated by an international maritime convention, namely the International Convention for the Safety of Life at Sea (SOLAS) propagated by the International Maritime Organization.

Liferings also incorporate a loosely threaded rope around the perimeter of the ring, which provides an additional gripping surface for the distressed individual, as well as an attachment point for a throw rope so that the individual can be towed aboard.

The features of the classic lifering as described above have not changed over many decades. There are opportunities to improve the functionality of both the lifering and rope, in particular to enhance the visibility of these components in conditions of low light. In particular, it would be beneficial to add night-time safety benefits to the lifering and rope, within the constraints of regional and SOLAS requirements.

### SUMMARY OF THE INVENTION

The invention relates to improvements in manufactured articles such as maritime rescue gear, but could be applied to other fields in which enhanced visibility of the given item in low light and nighttime conditions would be advantageous. For instance, gear used in underground drilling or mining, or deep water applications could also benefit from the features of the invention.

The invention relates in part to an improved lifering for maritime use. The lifering incorporates glow in the dark pigment into its outer shell which enhances the visibility of the lifering at night. Such glow in the dark pigments will glow for several hours in the dark, as long as the item was exposed to bright light such as sunlight during the daytime for at least a few minutes.

The lifering may also incorporate rope or another form of a line or cord such as tubular webbing, which is impregnated with IR pigment. Ropes may be made from polymers such as nylon, polypropylene, and/or polyester, which may be extruded into fibres and processed to form rope. Similarly, tubular webbing may be made from extruded fibres which are then woven into fabric and sewn into a flattened tube which is called tubular webbing. Tubular webbing is advantageous as it is particularly durable in both fresh and salt water environments and maintains its flexibility and suppleness over longer periods as compared to ropes. The double layers of the tube make the product durable without losing suppleness and pliability, and it is also less prone to unraveling. As compared to a typical rope, tubular webbing is also better able to hold knots without slippage, making it useful for emergency response/rescue applications.

In either case, the incorporated IR pigment causes the rope or tubular webbing component to be visible to rescue personnel who are wearing specialty infrared-viewing eyewear such as the aforementioned NVG incorporating infrared illuminators. This is advantageous because the brightness of GID pigment will fade over several hours if the item is not recharged by exposure to bright light. However, IR pigment remains visible indefinitely to those wearing NVGs with IR illuminating technologies, such as the Forward Looking Infrared (FLIR) cameras that are often incorporated into NVGs. Thus, the rope or webbing incorporating IR pigment offers a form of back-up visibility for the glow in the dark lifering in conditions of low visibility.

### BRIEF DESCRIPTION OF THE FIGURES

FIG. 1 is a front view of a GID lifering of the invention formed of polymer containing GID pigment, in ambient lighting.

FIG. 2 is a front view of the GID lifering of FIG. 1, in dark conditions.

FIG. 3 is a perspective view of braided rope having IR pigment incorporated, in ambient lighting.

FIG. 4 is a perspective view of the braided rope of FIG. 3, in bundled form and as viewed through NVGs with IR illuminating technologies.

### DETAILED DESCRIPTION OF THE INVENTION

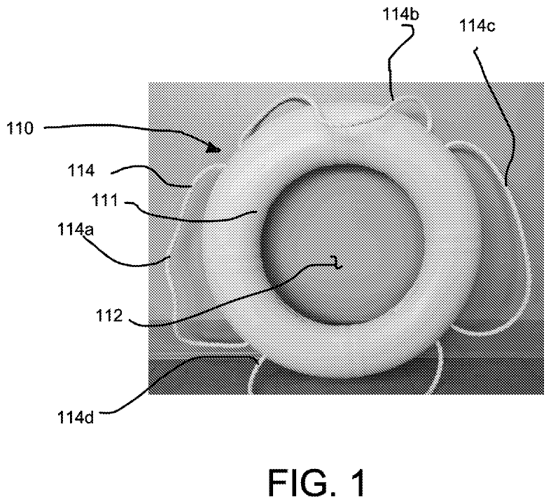

Buoyant articles are provided, and according to an exemplary embodiment, a buoyant article in accordance with the invention is embodied as a lifering 110, shown in FIG. 1. The lifering 110 is shown having a body portion 111, and an open center 112. A guide rope 114 is shown provided on the lifering body 111, and includes guide rope portions 114a, 114b, 114c and 114d.

The glow in the dark lifering of the present invention is structured as a hollow circular tube made of polyethylene that has glow in the dark pigment incorporated therein. Inside the tube, a foamed buoyant material such as polyurethane is used to fill the tube in order to increase the buoyancy of the article.

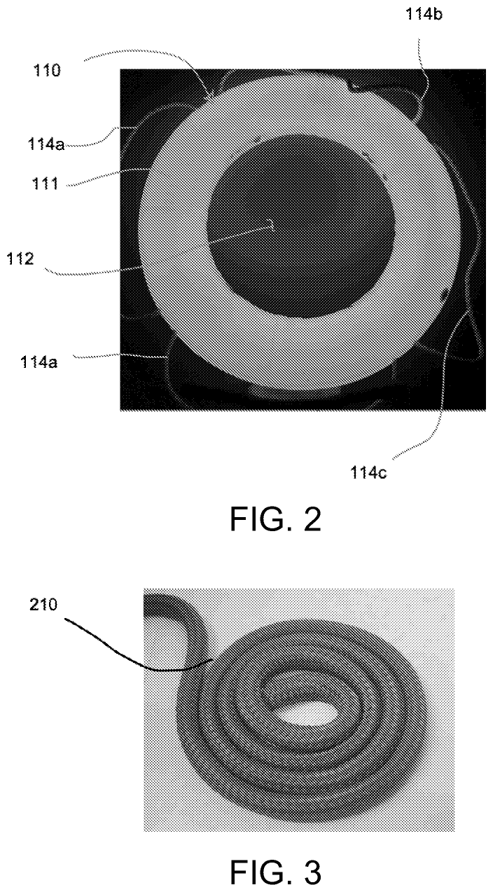

The tube may be made by various means. A preferred way to manufacture the tube is to mold two circular and concave halves of the lifering separately, join them with adhesive, and to fill the internal cavity with polyurethane. According to a preferred embodiment, the outer portion or tube of the lifering may be formed by producing the tube, and then filling the interior or cavity of the tube with a buoyant material, such as for example, a polyurethane, and more preferably a polyurethane foam. For example, according to a preferred implementation, a mold having the configuration of the resultant lifering shape is produced or obtained. The mold is filled with the suitable material that is to form the tube or exterior portion of the lifering. One example, of a material used to form the tube portion is polyethylene. The polyethylene is introduced into the mold, preferably in a liquid or molten form, and allowed to set. The resultant tube or workpiece is removed from the mold. Preferably the tube or workpiece formed includes a hollow interior cavity, with the tube forming the lifering exterior shaped like the ring shown in FIGS. 1 and 2. The tube or workpiece structure has an opening or port into which material, such as s the buoyant material, is introduced to fill the cavity and produce the lifering. The opening may be produced during the molding process or may be drilled into the ring after the tube is formed. Preferably, the polyethylene composition used to form the tube includes a photoluminescent pigment, so that the tube when formed into the lifering, will provide photoluminescent properties to the lifering, via the tube exterior. The mold also may include locations to place guide ropes therein that can be held in place with the polyurethane composition introduced into the mold. Alternatively, the guide ropes may be added after the tube is completed with the polyurethane filling. Preferably. The polyurethane used to fill the tube is an expanding polyurethane foam.

Specifically, the two halves of the lifering may be made by using a rotational mold into which a masterbatch, which is a pelleted form of plastic which has been premixed with additives such as pigments, is melted and poured. The material used may be any type of polymer that can form a durable and hard final product, and which is amenable to prior mixing with a glow in the dark pigment. Suitable materials include high density or low density polyethylene, polyimide, polytetrafluoroethylene, and polyphenylene sulfide. Many other polymers are suitable. Optionally, a UV stabilizer may also be incorporated in the polymer used so that the lifering is less prone to degeneration due to exposure to sunlight. Other additives such as flow promoters may also be included.

A number of glow in the dark pigments are commercially available and may be mixed with the polymer pellets prior to formation of the lifering. A particularly favoured pigment is strontium aluminate, which features a strong brightness and long glow period. Strontium aluminate absorbs photons when exposed to light, and will slowly give off photons producing a glow in the dark effect. Preferably, the strontium aluminate is pre-treated with europium or dysprosium to enhance the duration and brightness of the glow in the dark effect.

Suitably treated strontium aluminate may be sourced from multiple suppliers including Chroma Colors. Other glow in the dark pigments are available from manufacturers such as Sigma Aldrich, or under the brand name Super Luminova. The emission wavelength of the glow effect from strontium aluminate is in the range of 495-520 nm.

Glow in the dark pigments such as strontium aluminate may also be provided in various particle sizes, typically ranging from 2-300 μm. The larger sizes of particles can negatively impact the processability or moldability of the base polymer into which the particles are incorporated. For the invention, it has been found that particles of strontium aluminate in the range of 60-100 μm work best and are less likely to cause issues with manufacturing.

An exemplary embodiment of an article of the invention is illustrated comprising a lifering. According to a preferred embodiment, a lifering is prepared from a buoyant material and may be formed from one or more portions. According to one implementation and embodiment, to form the lifering of the invention, a masterbatch was used which incorporated polyethylene and strontium aluminate. Conveniently, such pellets can simply be poured into a heated mold and melted in the course of the manufacturing process. In the case of the invention, the masterbatch utilizes polyethylene mixed with strontium aluminate provided by Chroma Color Corporation.

To make the liferings of the invention according to an exemplary embodiment, a standard mold release spray is used to coat the rotational molds, and a flow promoter is also sprayed onto the mold inserts. The mold is then filled with a mixture containing, by weight, 90% masterbatch, and 10% natural polyethylene pellets. The mixture is then heated at 340° F. for 20 minutes in a suitable industrial oven, and cooled for 18 minutes in a cooling chamber. The resulting rings may then be demoulded, and any excess plastic trimmed from the edges. According to some implementations, the mold inserts may be used to define a thickness of the tube and produce a ring having a wall.

Optionally, if a red and white quartered pattern is desired for the ring, as is currently required for 30-inch liferings in accordance with SOLAS regulations, a convenient way to achieve this is to make the lifering as described above in a base colour such as white, and then to affix a translucent red film on top of portions of the surface in order to achieve the quartered pattern. For instance, a red thermoplastic translucent film available from RTP Plastics may be utilized. The glow of the lifering readily transmits through such a translucent film.

An example of the ring under normal light and dark conditions is shown in FIGS. 1 and 2.

According to some embodiments of the invention, rope or tubular webbing may also be prepared which incorporates IR pigment. To make the infrared-reflective filaments for the tubular webbing, another masterbatch process is used. A mixture comprising polymer (thermoplastic) and colanyl oxide is compounded and the resulting mixture is pelletized. Colanyl oxide is available from multiple sources, including CLARIANT Corporation. Such IR pigments operate to maximize the reflectivity of a surface, by reflecting infrared light while absorbing some spectrums of visible light. Ropes or webbing which include colanyl oxide will reflect IR light, which can be picked up by NVGs incorporating infrared illuminating technology, so that the webbing or rope can be readily seen in the dark. An advantage of IR pigments is that they do not require any charge time like glow in the dark pigments; they simply reflect IR that is already present. For example, the guide rope 114 shown in conjunction with the lifering 110 in FIGS. 1 and 2 preferably include IR pigment, and provide enhanced visibility in conditions where there is a lack of visible light.

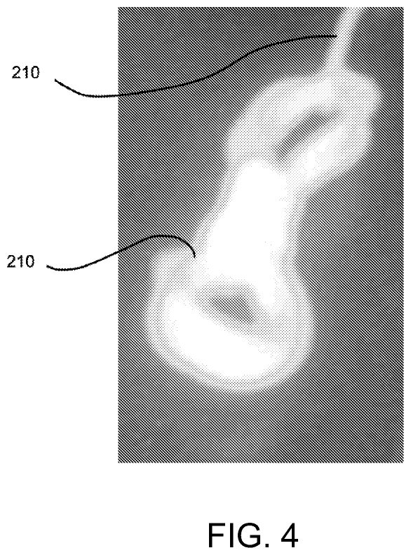

Rope or tubular webbing that incorporates IR reflecting pigment within the composition of the rope or webbing may then be cut and incorporated into the liferings. What results is a glow in the dark lifering which is supplemented by infrared-reflective rope or tubular webbing. This greatly enhances the visibility of the lifering in conditions of low light, facilitating the use of the lifering by rescue personnel to save distressed individuals, or to provide the distressed individual a target to swim towards. According to an exemplary embodiment a rope 210 is shown in FIG. 3, which is depicted formed in a braided configuration. The rope 210 has an infrared illuminator, such as an infrared illuminating pigment. The IR pigment preferably is incorporated into the rope as part of the components forming the rope. For example, the rope may be formed by extrusion, where the rope composition containing the IR reflecting pigment is extruded to form fibers which are then braided to form the rope. Although a single extruded strand may be used for a rope, the preferred embodiments provide braised fibers to produce a flexible and strong rope. Referring to FIG. 4, the infrared imaging of the rope 210 is depicted in a photograph taken by an infrared imaging apparatus, such as an IR camera, in the absence of visible light. The rope 210 is visible to the IR imaging apparatus, and provides a useful way of identifying the rope 210 as well as items to which it is attached at night or when visible light is not available. The rope 210 may be configured in different thicknesses and strengths, and, according to some embodiments, may be produced in suitable thicknesses and configurations for use as webbing.

According to some embodiments, the lifering 110 may be constructed having guide ropes 114 (i.e., 114a, 114b, 114c, 114d), and in addition or alternatively, may include webbing. The guide rope 114 and/or webbing preferably includes the IR pigment. One example of guide rope 114 comprises material that is attached to the main body of the lifering to provide for grasping, retrieving, throwing or other actions. The guide rope may be affixed to the lifering in any suitable manner. For example, the guide rope may be molded along with the production of the lifering, when the lifering is formed. According to another example, the guide rope may be applied to the lifering using a suitable connector, such as for example, straps, which span the ring at one or preferably a number of locations on the ring, and hold the guide ropes and/or webbing on the ring.

Embodiments of the lifering provide a photoluminescent composition as well as an IR reflective pigment. Preferably, the buoyant articles of the invention include both types of illuminators. The ring preferably includes a photoluminescent composition, and the guide rope and/or rope preferably includes the IR reflective composition. According to a preferred embodiment, the buoyant article is configured as a lifering 110 having guide ropes 114, and also may include an attaching rope 210 for tethering and/or retrieval. The lifering has a first portion that comprises a buoyant body; and a second portion comprising a tethering rope and/or guide rope and/or webbing, where the first illuminator is associated with the first portion and comprises a photoluminescent composition; and the second illuminator comprises an infrared illuminator that is associates with the tethering rope, guide rope and/or webbing. An embodiment includes the lifering and guide rope and/or webbing and a tethering rope, where the lifering ring portion or body has a photoluminescent composition that produces photoluminescence, and the guide rope and/or webbing and tethering rope have an infrared reflective pigment that exhibits IR illuminating properties.

Practical implementation may include any or all of the features described herein. These and other aspects, features and various combinations may be expressed as methods, apparatus, systems, means for performing functions, products-by-process, and in other ways, combining the features described herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described systems. Accordingly, other embodiments are within the scope of the following claims.

Throughout the description and claims of this specification, the word “comprise”, “include” and “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, unless the context requires otherwise.

The foregoing description illustrates only certain preferred embodiments of the invention. The invention is not limited to the foregoing examples. All of the features disclosed herein (including any accompanying claims, abstract and drawings), and/or all of the steps of any method or process so disclosed, may be combined in any combination, except combinations where at least some of the features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

What is claimed is:

1. A buoyant article comprising a first polymer containing particles of photoluminescent material distributed throughout said polymer, said article including a line comprised of a second polymer incorporating an infrared-reflective pigment.

2. The buoyant article of claim 1, wherein the article comprises a foamed buoyant material.

3. The buoyant article of claim 2, wherein the foamed buoyant material comprises polyurethane.

4. The buoyant article of claim 1, comprising a pair of portions, said portions being circular and concave, and forming an outer shell of the article, wherein said pair of portions are connected, and wherein a buoyant material is disposed between said portions.

5. The buoyant article of claim 4, wherein the buoyant materials comprises polyurethane.

6. The buoyant article of claim 4, wherein said pair of portions define an internal cavity of the article, and wherein said buoyant material is disposed in said cavity.

7. The buoyant article of claim 1, wherein the line comprises one or more of a guide rope or webbing.

8. The buoyant article of claim 1, wherein the line comprises a rope.

9. The buoyant article of claim 1, wherein said line infrared-reflective pigment comprises colanyl oxide.

10. The buoyant article of claim 9, wherein said line is comprised of a polymer including colanyl oxide.

11. The buoyant article of claim 7, wherein said one or more of a guide rope or webbing infrared-reflective pigment comprises colanyl oxide.

12. The buoyant article of claim 11, wherein said one or more of a guide rope or webbing is comprised of a polymer including colanyl oxide.

13. The buoyant article of claim 1, wherein said article comprises a lifering having a lifering body, wherein said line comprises a guide rope that is molded along with the foamed buoyant material to form the lifering body, and wherein at least one or more guide rope portions are outside the lifering body.

14. The buoyant article of claim 7, wherein said article comprises a lifering having a lifering body, wherein said one or more of a guide rope or webbing is applied to the lifering body with one or more straps.

15. A buoyant article comprising:
a) a first portion comprising a buoyant body; and
b) a second portion comprising one or more of a tethering rope, webbing and guide rope;
c) wherein the article comprises a first illuminator and a second illuminator, wherein the first illuminator comprises a photoluminescent composition;, and wherein the second illuminator comprises an infrared illuminator.

16. The buoyant article of claim 15, wherein the first illuminator is provided in the first portion, and wherein the second illuminator is provided in the second portion.

17. The buoyant article of claim 16, wherein the first portion is configured as a ring having a thickness and defining an open center.

18. The buoyant article of claim 17, wherein the second portion comprises at least a guide rope attached to said ring.

19. The buoyant article of claim 18, wherein the second portion further comprises a tethering rope attached to the first portion or to the guide rope.

20. The buoyant article of claim 15, wherein the infrared illuminator comprises an infrared-reflective pigment, and wherein the infrared-reflective pigment comprises colanyl oxide.
